(19) United States
(12) Patent Application Publication
(10) Pub. No.: US 2018/0239435 A1
(43) Pub. Date: Aug. 23, 2018

(54) SMART DEVICES HAVING RECOGNITION FEATURES

(71) Applicant: INTERNATIONAL BUSINESS MACHINES CORPORATION, Armonk, NY (US)

(72) Inventors: Maryam Ashoori, White Plains, NY (US); Lei Shi, Ithaca, NY (US); Yunfeng Zhang, Yorktown Heights, NY (US)

(21) Appl. No.: 15/439,457

(22) Filed: Feb. 22, 2017

(51) Int. Cl. G06F 3/01; G06F 1/16; G06F 3/16

(52) U.S. Cl. CPC G06F 3/017; G06F 3/16; G06F 1/163

(57) ABSTRACT

A smart action can be performed in response to acquiring feature information associated with a user performing a gesture on an object. The acquired acoustic information is matched with a predetermined acoustic signature that is associated with a smart action. The smart action is initiated in response to the matching.

### BACKGROUND

The present invention relates to smart devices and, more specifically, feature recognition by smart devices.

A smart device is an item such as an appliance or article that incorporates computer technology. Such items can be common items that have traditionally not made use of computer technology. Many smart devices can communicate such as through a connection to a network, such as the Internet. Smart devices have accordingly come to be considered part of the Internet of Things (IoT).

### SUMMARY

One embodiment of the present invention is a computer-implemented method for triggering a smart action includes acquiring acoustic information while a user performs a gesture on an object. The acquired acoustic information is matched with a predetermined acoustic signature that is associated with a smart action. The smart action is initiated in response to the matching.

Other embodiments include a system and computer program product.

### BRIEF DESCRIPTION OF THE SEVERAL VIEWS OF THE DRAWINGS

A more complete appreciation of the present invention and many of the attendant aspects thereof will be readily obtained as the same becomes better understood by reference to the following detailed description when considered in connection with the accompanying drawings, wherein:

FIG. 1 is a schematic diagram illustrating a system for implementing a smart device in accordance with one or more exemplary embodiments of the present invention;

FIG. 2 is a schematic diagram illustrating a wearable device according to one or more exemplary embodiments of the present invention;

FIG. 3 is a flow chart illustrating a method in accordance with one or more exemplary embodiments of the present invention;

FIG. 4 is a flow chart illustrating another method in accordance with one or more exemplary embodiments of the present invention; and

FIG. 5 shows an example of a computer system according to one or more exemplary embodiments of the present disclosure.

### DETAILED DESCRIPTION

In describing one or more exemplary embodiments of the present invention illustrated in the drawings, specific terminology is employed for sake of clarity. However, the present invention is not intended to be limited to such illustrations or any specifics, and it is to be understood that each element includes all equivalents.

By way of overview, one or more exemplary embodiments of the present invention relate to an item or article that is not initially a smart device (an “ordinary” object) but may become a smart device e.g., by one or more practices described herein. Once the ordinary object has become a smart device, interactions with the smart device may be used to trigger various computerized functions (“smart functions”). For example, an ordinary table may be made to be a smart table and a user knocking upon the smart table may initiate a predefined smart function such as unlocking a door, changing room temperature, or turning on a light.

One or more exemplary embodiments of the present invention need not install electronics into the ordinary object in order for it to trigger one or more smart functions. Further to the above example, one or more embodiments of the present invention may utilize a device that is worn by a user (a “wearable device,”) adapted to detect an acoustic pattern associated with the user's knocking upon the table, which triggers the desired smart function, e.g., unlocking the door.

As will be described in greater detail below, with reference to the figures, one or more exemplary embodiments of the present invention may utilize various other systems and techniques to transform ordinary objects into smart devices.

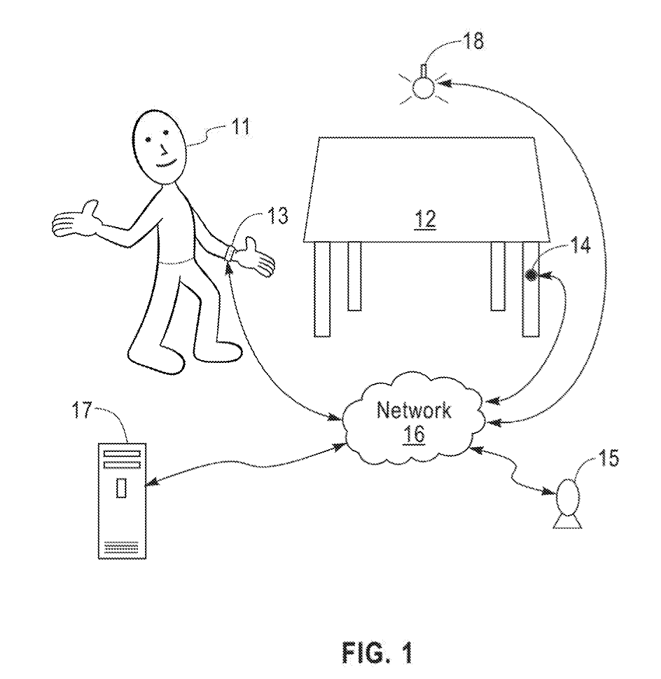

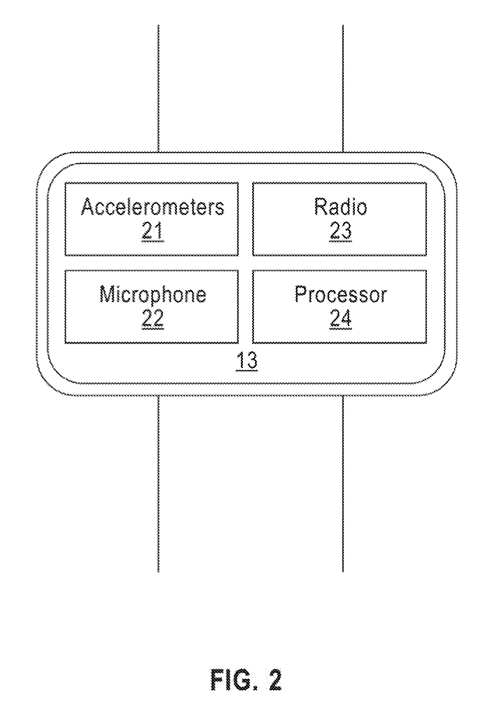

FIG. 1 is a schematic diagram illustrating a system for implementing a smart device in accordance with one or more exemplary embodiments of the present invention. As depicted, a user 11 may make use of the system. The user 11 may knock upon an object such as a table 12. The user 11 may wear a wearable device 13, such as a smart watch. The wearable device 13, an example of which will be described in greater detail with reference to FIG. 2, may use various sensors such as accelerometers to assist in a determination of when user 11 is engaged in a knocking motion. When it is determined, e.g., based on accelerometer data from the sensors of the wearable device 13, that the user 11 is engaged in knocking, acoustic information may also be obtained. By making use of the accelerometer data to make an initial determination of when the user 11 is engaged in knocking, false (e.g., contemporaneous, similar-sounding acoustic information may be ignored, for example, by not being obtained in the first place.

In other words, according to an exemplary (multi-verification) approach, the acquisition of acoustic information may be dependent upon one or more other verifications that the user 11 is knocking, for example, using accelerometer data acquired by the wearable device 13 worn by the user 11.

The acoustic information may be acquired, for example, using one or more microphones 22 disposed within the wearable device 13. Alternatively, or perhaps additionally, the acoustic information may be acquired using one or more microphones disposed elsewhere within a room containing the table 12. For example, a network-connected device 15, that may include one or more microphones (not depicted), for acquiring acoustic information.

A computer network 16, for example, a local area network (LAN) such as a home WiFi network, and/or a wide area network (WAN) such as the Internet, may be used to connect the wearable device 13 to a central server 17 via network connected device 15. The central server 17 may be instantiated as a computer system located in a same facility as the table 12, or the central server 17 may be instantiated as a cloud-based service. Logic for analyzing the acquired acoustic information and potentially matching the acquired acoustic information to a known acoustic pattern, an example of which will be discussed in greater detail below, may be embodied in the hardware of the wearable device 13 and/or the central server 17.

Alternatively, or perhaps additionally, an acoustic transducer 14 may be mounted on the table 12 itself to acquire the acoustic information by conduction of sound through the table 12. By acquiring the acoustic information in this way, ambient sounds (e.g. noise) that may travel through the air may be rejected without the need to use the accelerometer data discussed above. However, the accelerometer data may still be used to reject other sounds that may travel through the table 12 such as accidental kicks or other ways in which the table 12 may be struck.

The acoustic transducer 14 may also he in communication with the computer network 16, for example, using a WiFi connection, an Ethernet connection, or some other means of wired or wireless connection.

The acoustic information may he used to initiate the performance of a smart function, such as turning on a light. This may be accomplished by obtaining an acoustic signature of the knocking upon the table 12, for example, as performed by the user 11, and then matching the acquired acoustic information to the acoustic signature. The user 11 may specify the desired smart function, which may be, for example, turning on the light 18.

It should be noted that the user 11 need not be a human user, as one or more exemplary embodiments of the present invention may enable pets, for example, wearing a smart collar as the wearable device 13, to initiate smart functions such as opening doors, dispensing food, etc. upon the detection of an action such as scratching on or bumping against a door or post, rather than the table 12. Other smart actions may include activating a surveillance system when someone knocks on a door, sending out a text message to family members that dinner is ready by knocking on a dining table, etc.

The wearable device 13 need not be limited to a smart watch, and may be the aforementioned smart collar, a smart bracelet, a smart garment, a smartphone or tablet computer, etc. In this way, the wearable device 13 may be any device that is worn or held by the user 11. As described above, the smart device 13 may include a microphone and an accelerometer. However, other sensors may be used to determine when the user 11 is engaging in the predetermined action for triggering the smart function.

The example presented above utilizes a table as the ordinary object that is transformed into the smart device, however, other ordinary objects may be uses such as other articles of furniture, walls, doors, floors, household fixtures, household appliances, etc. The triggering action need not be limited to a knock and may alternatively be a kick, tap, pat, rub, brush, slap, bump, etc. made using the user's hand, foot, leg, head, mouth, etc. Indeed, as one or more exemplary embodiments of the present invention may be particularly beneficial to users with limited mobility or other motor capabilities, selection of the triggering action and the ordinary object may be made based on what sorts of actions the particular user is able to make.

The acoustic transducer 14 may be mounted to the ordinary object, such as the table 12, for example, by an adhesive and/or straps, etc. The acoustic transducer 14 may be battery operated, where it is not convenient to plug the acoustic transducer 14 into a walk However, according to one exemplary embodiment of the present invention, the acoustic transducer 14 is instantiated as a wall-plug that plugs into an electrical outlet and is acoustically coupled to the wall or otherwise uses one or more microphones to acquire the acoustic information so that the wall may he transformed from the ordinary object to the smart object. In this case, the user 11 could initiate a smart function by knocking on the wall.

The example provided above uses turning on a light 18 as the smart function, however other smart functions may be performed such as mechanically opening or closing doors, windows, or any other action that a user may wish to be performed. The smart function may be performed on any object that is electronically or mechanically controlled by a device that is in communication with the computer network 16 or otherwise in direct communication with the microphone or acoustic transducer.

FIG. 2 is a schematic diagram illustrating a wearable device 13 according to an exemplary embodiment of the present invention. While the wearable device 13 may be any device that is worn or held by the user, for purposes of this example (only), the wearable device 13 is a smartwatch. The wearable device 13 may include one or more accelerometers 21 for detecting associated information, for example, a knocking motion or other a gesture by the user. One or more microphones 22 may also be included for acquiring the acoustic information. The wearable device 13 may also include one or more processors 24 for processing detected/acquired information and executing one or more computer program instructions stored in a memory (not depicted) associated with the smartwatch wearable device 13. In some embodiments, the execution of such computer program instructions by the one or more processors 24 can implement a method (examples of which will be described in more detail below) in accordance with the present invention. The acoustic information may alternatively, or additionally, be acquired by the use of an acoustic transducer (not shown) incorporated into the smartwatch wearable device 13. In such a case, the acoustic transducer can pick up sounds transmitted through the arm of the user so that the user can initiate a smart action by tapping his or her own arm. In this case, the user's arm is in a sense, the smart device.

The smartwatch wearable device 13 may also include one or more radios 23 such as cellular, WiFi, or Bluetooth radios. The smartwatch wearable device 13 may utilize the one or more radios 23 to communicate with the aforementioned central server 17 via the wireless network 16 of FIG. 1. However, in some embodiments, the smartwatch wearable device 13 may itself perform the function of the central server 17 using its processor 24, where suitable computational power is available.

The wearable device 13 may also include a touchscreen for providing both input and output. The wearable device 13 may be programmed with a user interface (“UI”) for facilitating instruction input, and this UI may be, for example, a touch-sensitive UI.

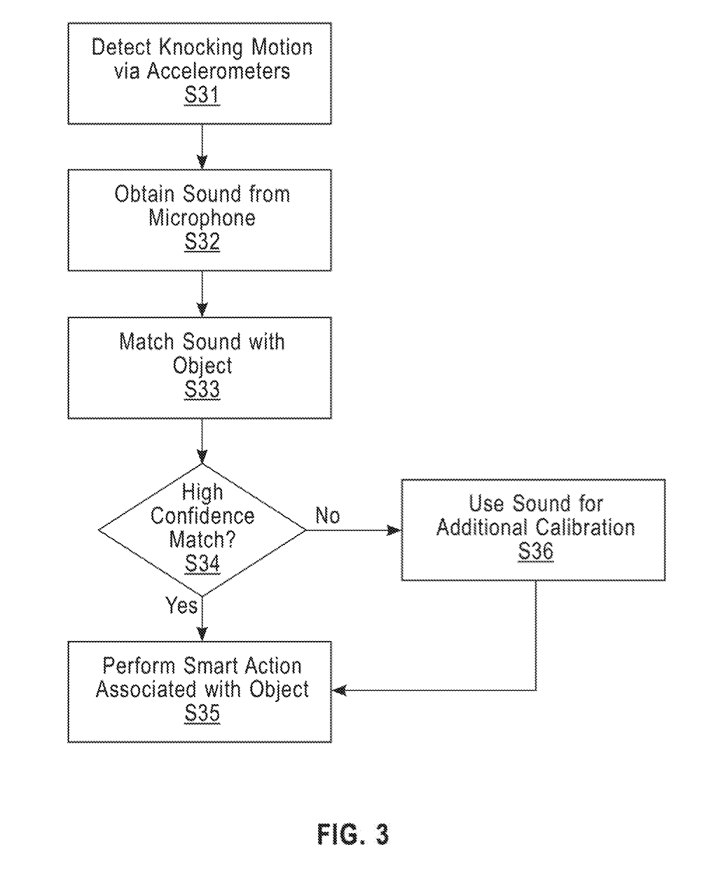

FIG. 3 is a flow chart illustrating a method for performing acoustic recognition for initiating smart actions in accordance with one or more exemplary embodiments of the present invention. In some embodiments, the method is performed after a calibration has been conducted. Calibration, as used herein and as will be further described in examples below, generally refers to a process for associating acoustic information, e.g., one or more acoustic signatures, to smart functions.

As depicted in FIG. 3, in step S31, the method may begin with the detection of a knocking motion using accelerometers of a wearable device worn by a user. As mentioned above, the action of knocking is presented by way of example only, and other actions may be so detected using accelerometers or other sensors capable of detecting movement. In some embodiments, the detection of the knocking motion is an optional step. However, where detection of the knocking motion is used, this detection is based on motion information, and not acoustic information. By using motion information as a precondition for acoustic matching, one or more embodiments of the present invention may lower false positive matches by avoiding accidental knocks and other similar sounding events. The detection of the knocking motion may be processed either within the wearable device or within the central server, however it is instantiated. In so doing, the accelerometer and/or other motion information, may be transmitted to the central server, for example, via the computer network.

Upon the detection of the knocking motion, acoustic information may be acquired from one or more microphones, in step S32.

The acoustic information may be obtained in step S32 using one or more microphones and/or acoustic transducers, for example, as described above.

In some embodiments, steps (S31 and S32) may be performed by continuously monitoring accelerometer data while not monitoring acoustic information, and then initiating the monitoring of the acoustic information upon the positive identification of the knocking motion. In some embodiments, such steps may be performed by continuously monitoring accelerometer data while recording a window of acoustic information within a buffer and then sending the buffered acoustic information for matching upon the positive identification of the knocking motion. A combination of these and/or other approaches may be used.

In step S33, the acoustic information may be matched, e.g., by the central server/wearable device, based on acoustic signatures that were defined during calibration. In some embodiments, the acoustic matching, may leverage certain metadata associated with the ordinary object (e.g. table). For example, the calibration process may have included an identification of an acoustic signature and it may be understood, by the acoustic matching, that the acquired acoustic information is a sound of a table, a sound of a chair, etc. Thus one or more exemplary embodiments of the present invention may identify the type of object being struck (e.g. a table) or the specific object being struck (e.g. a glass portion of a living room coffee table). However, such an object identification is optional, since some embodiments may perform acoustic matching without identifying the type or specific object being struck.

The matching (in step S33) of the acoustic information with the acoustic signatures may be performed, for example, by analyzing frequency-domain features to find a match. The acquired acoustic information may be in the form of a time-domain signal. A Fast Fourier Transform (FFT) may be used to transform the time-domain signals into a set of frequency-domain features. Then, a k-Nearest Neighbors (kNN) classifier may be used to compare the acquired acoustic information with the acoustic signature.

For example, where f(t) represents the acquired acoustic information (e.g. a time-domain signal). A FFT may be used to transform f(t) to F(f), which is a set of frequency-domain features:

F(f)=∫_{-∞}^{+∞}f(t)e^{-j2πft}dt

The kNN classifier may be used to classify the frequency-domain features of the acoustic feedback. To do so, the kNN classifier may calculate a Euclidean distance between the features of the acquired acoustic information and the features of the acoustic signature, and output the classification results based on the k-nearest samples' labels.

A determination of a match may include a measure of the degree of similarity between the acoustic information and the acoustic signature it is compared to. If there is no match e.g., similarity, between the acoustic information and the one or more acoustic signatures that have been linked to smart actions then the process may restart (e.g., return to step S31) and repeat until which time that a match is made.

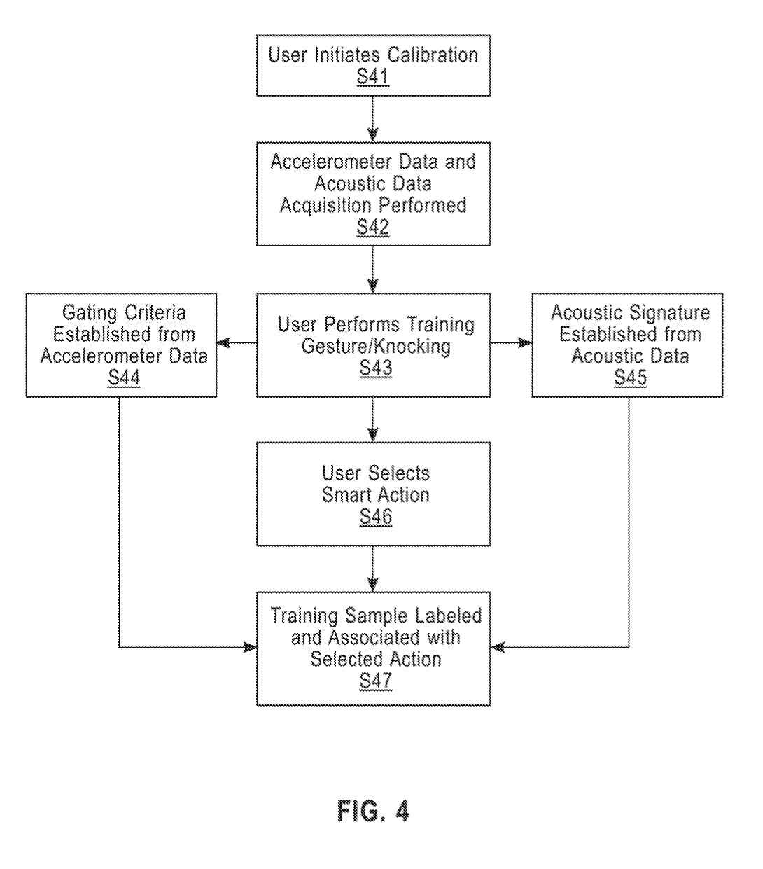

After the match has been made, a confidence level in the match may be determined e.g., whether there is a high confidence in the match, in step S34. The confidence in the match may be based on an analysis a degree of similarity between the acoustic information and the acoustic signature it has been matched to. If the confidence of level of the match is sufficiently high, the associated smart action will be performed, in step S35. If the confidence of the match is not sufficiently high, further to the mention above, the process may restart (e.g., return to step S31) and repeat until which time that a sufficiently similar match is determined. In some embodiments, the acoustic information may be further used for additional calibration, in step S36 so that the ability to match acoustic information with smart actions may be (e.g., relatively dynamically) improved with use. An example of such additional calibration will be described in more detail below with respect to steps S43-S47 of FIG. 4. In some embodiments, one or more of steps S34 and S36 may also reflect input by the user. In some embodiments, the smart action may also be performed (S35) even while the additional calibration is performed. In other embodiments, the smart action is not performed unless confidence is sufficiently high.

FIG. 4 is a flow chart illustrating a method for calibrating acoustic information to smart actions in accordance with one or more exemplary embodiments of the present invention. As depicted, in step S41, an initial calibration can begin. This may occur, for example, when a user wishes to associate an event, such as a knock on a table, with a smart action. The user may initiate calibration, for example, by sending an instruction to the central server directly via a wearable device or indirectly e.g., via a network connected device 15 (FIG. 1) such as an authorized smart phone (not depicted). In step S42, accelerometer data may be monitored from the wearable device and acoustic information may be acquired.

The user may then begin to perform the desired training action, for example, knocking on a table, in step S43. The accelerometer data and acoustic information associated with the desired action may thereby be acquired and from this knowledge, the system may infer criteria for recognizing similar actions (S44). This may be accomplished, for example, using machine learning to train a classifier. The criteria for recognizing similar action may be referred to as gating criteria, as it is the recognition of this action that may initiate the acquisition of acoustic information during the process for performing smart action discussed above (e.g. in step S32 of FIG. 1).

By limiting the acquisition of acoustic information based on the accelerometer data, exemplary embodiments of the present invention may also allow for multiple different users to program different smart actions for the same sound. For example, a first user may use knocking on a certain table to indicate turning on the lights while a second user may use knocking on the same table to indicate unlocking a door. Because each user may wear their own smartwatch, there is no ambiguity as to whether a knock on the table represents an instruction to turn on the light or to unlock the door. A unique identifier associated with each smartwatch may be associated with the accelerometer data, and in this way, the system may recognize for which user the sound is being identified so that the correct smart action may be performed. In this regard, during the training, the unique identifier may also be considered.

Additionally, the acoustic signature may be established from the acoustic information acquired in Step S42. In so doing, acoustic information acquired at a period of time prior to the performance of the gating criteria may be rejected, and, for example, only the sound made after the accelerometers have established that the knock has been initiated might be used. From this acoustic information, the acoustic signature may be created, in step S45. Creation of the acoustic signature may also be performed using machine learning to train a classifier.

In training the classifiers for the motion and the acoustic match, the user may be asked to repeat the action two or more times, until the classifiers may be suitably trained and as discussed above, additional calibration may be performed when a match is made with inadequate certainty. This may apply for both the acoustic match as well as the motion match, by which the accelerometer data is analyzed.

In step S46, the user may select a smart action (e.g. turning on the light) to associate with a triggering event e.g., triggered by the knock). The selected smart action may then be labeled and associated with the acoustic and motion matches, in step S47, and also the unique identifier of the particular smartwatch/wearable device. The user may similarly calibrate (train) as many other smart actions as are desired.

Calibration need not be performed by the user. The system may be configured to be calibrated in response to various activities. For example, an additional (e.g., supplemental) calibration may be triggered as described with reference to step S36 of FIG. 3. Such activities may be associated, for example by the user (or the system), with one or more smart actions. In some embodiments, one or more calibrations may be shared between users and/or between systems, for example, via crowdsourcing,

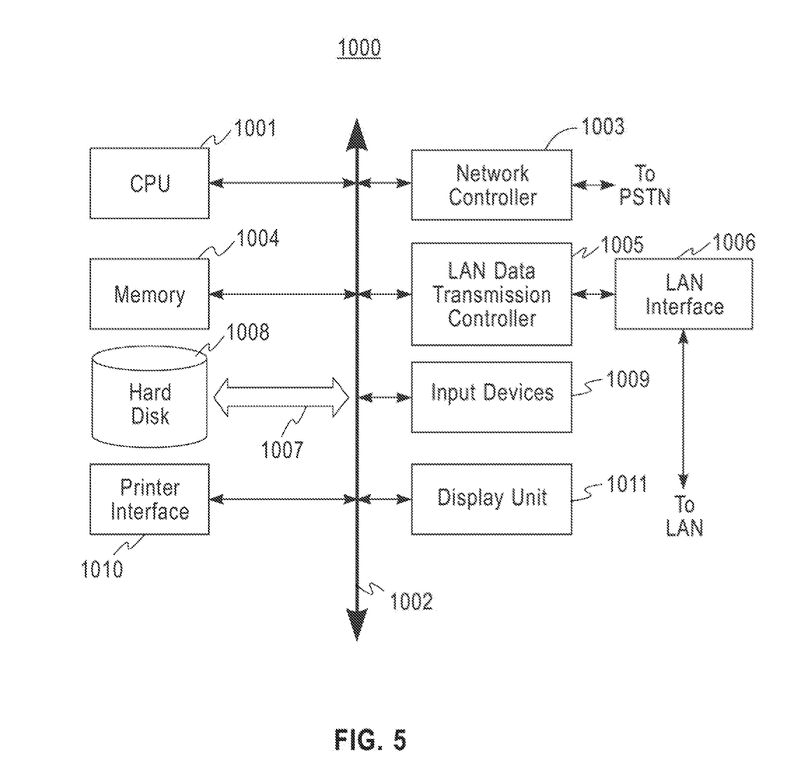

FIG. 5 shows another example of a system, in accordance with some embodiments of the present invention. By way of overview, some embodiments of the present invention may be implemented in the form of a software application running on one or more (e.g., a “cloud” of) computer system(s), for example, mainframe(s), personal computer(s) (PC), handheld computer(s), client(s), server(s), peer-devices, etc. The software application may be implemented as computer readable/executable instructions stored on a computer readable storage media (discussed in more detail below) that is locally accessible by the computer system and/or remotely accessible via a hard wired or wireless connection to a network, for example, a local area network, or the Internet.

Referring now to FIG. 5, a computer system (referred to generally as system 1000) may include, for example, a processor e.g., central processing unit (CPU) 1001, memory 1004 such as a random access memory (RAM), a printer interface 1010, a display unit 1011, a local area network (LAN) data transmission controller 1005, which is operably coupled to a LAN interface 1006 which can be further coupled to a LAN, a network controller 1003 that may provide for communication with a Public Switched Telephone Network (PSTN), one or more input devices 1009, for example, a keyboard, mouse etc., and a bus 1002 for operably connecting various subsystems/components. As shown, the system 1000 may also be connected via a link 1007 to a non-volatile data store, for example, hard disk, 1008.

In some embodiments, a software application is stored in memory 1004 that when executed by CPU 1001, causes the system to perform a computer-implemented method in accordance with some embodiments of the present invention, e.g., one or more features of the methods described with reference to FIGS. 3 and/or 4.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also he stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

One or more exemplary embodiments described herein are illustrative, and many variations can be introduced without departing from the spirit of the invention or from the scope of the appended claims. For example, elements and/or features of different exemplary embodiments may be combined with each other and/or substituted for each other within the scope of this invention and appended claims.

What is claimed is:

1. A computer-implemented method for triggering a smart action, comprising:
acquiring acoustic information while a user performs a gesture on an object;
matching the acquired acoustic information with a predetermined acoustic signature that is associated with a smart action; and
initiating the smart action in response to the matching.

2. The method of claim 1, further comprising:
identifying that the gesture is being performed based on motion information; and
acquiring the acoustic information after the performance of the gesture has been identified based on the motion information.

3. The method of claim 2, wherein the motion information is acquired by an accelerometer.

4. The method of claim 3, wherein the accelerometer is disposed within a wearable device worn by the user at the time of the performance of the gesture.

5. The method of claim 4, wherein the acoustic information is acquired by a microphone disposed within the wearable device.

6. The method of claim 1, wherein the object is selected from the group consisting of a wall, floor, door, or article of furniture.

7. The method of claim 1, wherein the gesture is a knock, kick, tap, pat, rub, brush, slap, bump, or scratch.

8. The method of claim 1, wherein the smart action is an activation/deactivation of an electronic device or the initiation/cancelation of a feature thereof.

9. The method of claim 1, wherein a central server receives the acquired acoustic information from a microphone, stores the predetermined acoustic signature, performs the matching, and initiates the smart action in response thereto.

10. The method of claim 1, wherein when the matching of the acquired acoustic information with the predetermined acoustic signature that is associated with a smart action is performed with a confidence level that is below a predetermined threshold, a user is prompted to define the smart action for the acquired acoustic information.

11. A system for triggering a smart action, comprising:
a processor;
a memory, operably coupled to the processor, the memory comprising program instructions that when executed by the processor, cause the system to;
acquire acoustic information while a user performs a gesture on an object;
match the acquired acoustic information with a predetermined acoustic signature that is associated with a smart action; and
initiate the smart action in response to the matching.

12. The system of claim 11, wherein the memory further comprises program instructions that when executed by the processor, cause the system to:
identify that the gesture is being performed based on motion information; and
acquire the acoustic information after the performance of the gesture has been identified based on the motion information.

13. The system of claim 12, wherein the motion information is acquired by an accelerometer.

14. The system of claim 13, wherein the accelerometer is disposed within a wearable device worn by the user at the time of the performance of the gesture.

15. The system of claim 14, wherein the acoustic information is acquired by a microphone disposed within the wearable device.

16. The system of claim 11, wherein a central server receives the acquired acoustic information from a microphone, stores the predetermined acoustic signature, performs the matching, and initiates the smart action in response thereto.

17. A computer program product for triggering a smart action, the computer program product comprising a computer readable storage medium having program instructions embodied therewith, the program instructions executable by a computer to cause the computer to:
acquire, by the computer, acoustic information while a user performs a gesture on an object;
match, by the computer, the acquired acoustic information with a predetermined acoustic signature that is associated with a smart action; and
initiate, by the computer, the smart action in response to the matching.

18. The computer program product of claim 17, wherein the program instructions executable by the computer additionally causes the computer to:
identify that the gesture is being performed based on motion information; and
acquire the acoustic information after the performance of the gesture has been identified based on the motion information.

19. The computer program product of claim 18, wherein the motion information is acquired by an accelerometer.

20. The computer program product of claim 19, wherein the accelerometer is disposed within a wearable device worn by the user at the time of the performance of the gesture.
